(19) United States
(12) Patent Application Publication
(10) Pub. No.: US 2003/0146908 A1
(43) Pub. Date: Aug. 7, 2003

(54) Display devices

(76) Inventors: Gregg E. Favalora, Arlington, MA (US); Joshua Napoli, Winchester, MA (US); Rick K. Dorval, Goffston, NH (US); Michael G. Giovinco, Cambridge, MA (US); Deirdre M. Hall, Beverly, MA (US); Michael J. Richmond, Holliston, MA (US); David H. Oliver, Brookline, MA (US)

Correspondence Address: CANTOR COLBURN, LLP, 55 GRIFFIN ROAD SOUTH, BLOOMFIELD, CT, 06002

(21) Appl. No.: 10/306,070

(22) Filed: Nov. 27, 2002

Related U.S. Application Data
(60) Provisional application No. 60/333,708, filed on Nov. 28, 2001.

(51) Int. Cl. G09G 5/00

(52) U.S. Cl. 345/204

(57) ABSTRACT

A display having pixels and subpixels adapted to cause light to escape with a directed profile.

### CROSS REFERENCE TO RELATED APPLICATIONS

This application claims the benefit of an earlier filing date from U.S. Provisional Application Serial No. 60/333,708 filed Nov. 28, 2001, the entire disclosure of which is incorporated herein by reference.

This document discloses several approaches for creating displays which have as properties one or more of the following:

1. Two-dimensional display

2. Multi-view display (two-dimensional or three-dimensional display which appears to produce a different image depending on the position(s) of an observer)

3. May be applied to unusual substrates (wall, vehicle, airplane, building, table)

4. Uses self-assembly

5. Uses self-organization/self-synchronization

6. Is reflective or emissive

For example, one display described here is a multi-view display which may be applied by a paintbrush onto the side of an object. Each pixel is comprised of several sub-pixels, mounted on a small (1 mm×1 mm) substrate containing synchronization and communications circuitry; each sub-pixel has associated with it a light-directing element such as a lens or diffraction grating. When applied to a large surface, an accelerometer in each pixel senses a common reference vector (gravity, or “down”). A master control unit or a distributed control system provides imagery to each pixel corresponding to several “views” from different angles. By this method the object vehicle can be concealed if the imagery appears to be perspective-corrected images of the landscape behind it. For example, where a desirable view is obstructed by something (water tower, building, etc.) the view seen by an observer can be as if the undesirable object were not there at all. Applications include: (1) large-scale TVs for home use; your living-room wall as a 3-D display, (2) applications (turn arbitrary surfaces, such as mountains, buildings, or vehicles, into 3-D illusions).

Relevant information includes:

1. Alien Technology (fluidic self-assembly of 2-D displays; small emitters in a fluid are washed over a pock-marked substrate, where they lodge into place and are driven by a control unit)—see http://www.alientechnology.com/technology/overview.html, incorporated herein by reference.

2. E-Ink/MIT Media Lab/(bistable electrophoretic displays—reflective particles encapsulated in a transparent sphere, controlled by an applied electric field)

3. Gyricon/Xerox PARC (bistable displays; spherical pixels with white and black halves; embedded in rubber sheet; rotated by external magnetic field)

Several Displays Which may be Applied in the Field

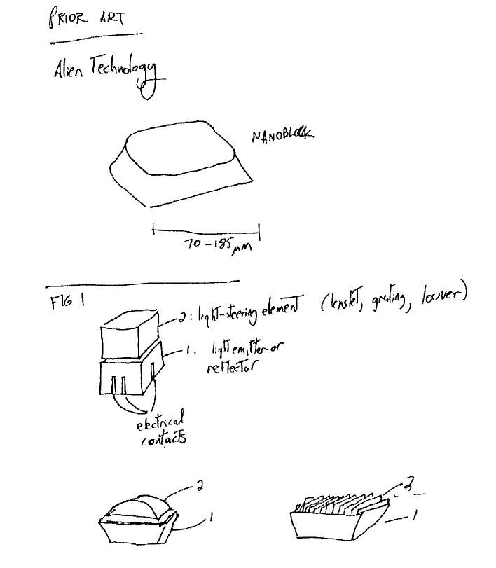

1. Pixel with light-steering element applied to surface. In aggregate, from a distance, each viewing zone will be served. Pixels synchronize/communicate as above. (See FIG. 1) Each pixel isn't just an emitter or reflector—instead, on top is a light-steering element (such as a louver, diffraction grating, or a tiny lens).

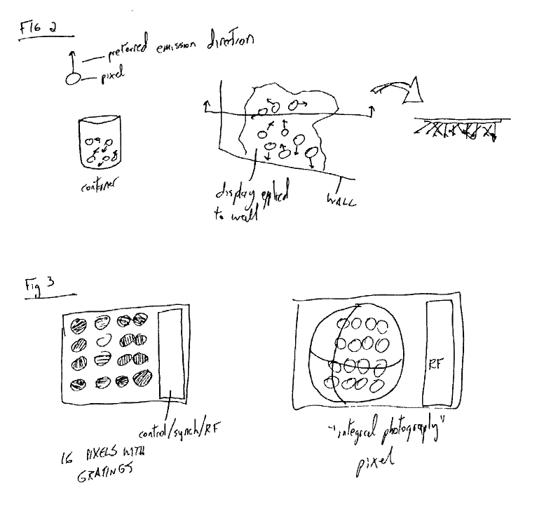

Either throw the pixels onto the wall, or first embed them in groups of 16. Then, for a large enough number of emitters, you paint the equivalent of a giant lenticular display or parallax-barrier display onto the wall. Except that there might or might not be a strict order to what all of the orientations of the pixels are. They just end up being uniformly distributed, for a large enough number of pixels. The result is the functional equivalent of a huge lenticular display or integral photograph on the wall, without an obvious ribbed or bumped texture. (FIG. 2)

2. Pixel formed of subpixels. On a substrate, an array of 16 subpixels are underneath a cylindrical or spherical lenslet, or an array of 16 diffraction gratings.

Do it like old integral photography, in which spherical lenslets are placed over clumps of emitting regions whose light is designated for various viewing zones. Each pixel is comprised of N subpixels, each of which emits light to a different viewing zone. In aggregate these pixels form a full-parallax display. (That is, take 16 pixels and place a plano-convex lens on top. Place a few of these onto a grain which is able to sense its orientation (see below). Paint the grains onto the wall.) See FIG. 3.

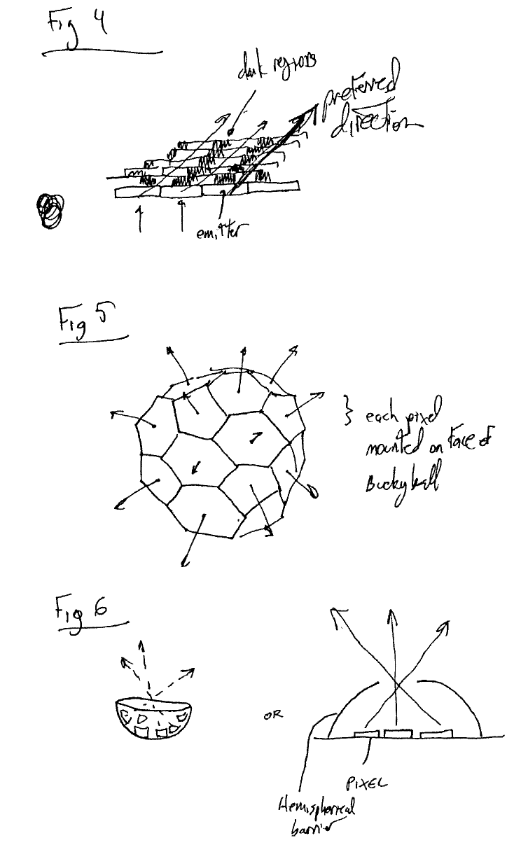

3. The pixels are of two types, or equivalently have two segments: (1) a light-emitting or reflecting segment (pixel), and (2) an opaque segment. The pixels are bonded together or self-assembled together in such a way that they stack up providing “transparent channels” through which light can pass. That is, they in aggregate act as a louver. And in greater aggregate, all possible light-steering directions are made. See FIG. 4.

4. Use a multifaceted pixel with emissive faces—such as a buckyball. Each side of the buckyball emits in a preferred direction. See FIG. 5. Or, place buckyballs onto substrate as an array of hemispheres.

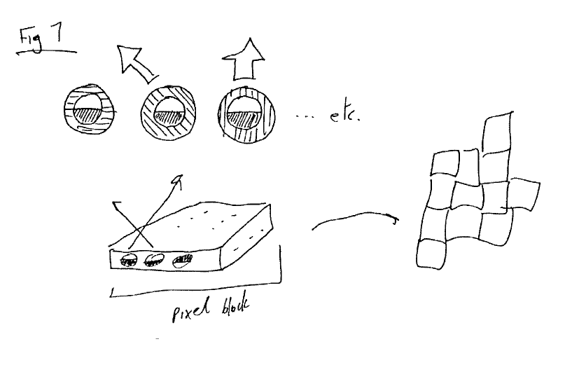

5. Similarly to integral photography, place emitters on the inside of a concave surface, or on a flat surface. Place a hole on top to permit viewing of the proper pixel. See FIG. 6. (David Oliver)

6. There are a host of ideas involving a standard projector . . . why not paint the wall with a directional material and set up an array of projectors on the ground? Or create thermal gradients for a controlled mirage.

7. Create a display similar to Gyricon, however, make each spherical pixel emit preferentially in one direction. The balls will randomly fall into different orientations. Sensing system will sense their orientation, as below. (Or create N types of Gyricon pixels, each of which has a directional element associated with the black/white hemisphere.) See FIG. 7.

8. Create a display on the surface using any of the above methods. Add the light-shaping layer as a second step. For instance, roll a holographic optical element onto the finished structure and calibrate (below). Or spraypaint a thin layer of directional elements, such as anamorphic lenslets, onto the surface. In aggregate these will address many viewing zones. A “calibration” step will determine which pixels emit in what direction.

How Pixel Orientation is Sensed

1. Magnetic. Each block of subpixels contains a magnetic field sensor that aligns to the Earth's field, or to a reference magnet placed near the display.

2. Gravitational. Each block of subpixels contains an accelerometer that indicates “down.”

3. Light. Shine a light onto the display from a series of reference orientations. The subpixels can contain a combination of light emitters (or reflectors) and light sensors which share the same sense of directionality. Place a reference light at a location, turn it on, and the pixels which prefer that direction will sense the light. Then, during operation, show the 2-D imagery designed for that direction only to those subpixels.

Calibration

Set up a camera at a location and turn on all pixels. Record which pixels are viewable. Repeat the process for several camera locations and several pixel patterns. This process will allow you to deduce which pixels prefer which directions.

Reflection Hologram

Imagine a flexible, stretchy, reflective sheet. The back of it is covered by a material that expands or shrinks when electric charge is applied. In back of that is a very dense layer of electrodes and the circuitry to drive them. If the lighting is controlled or known (and approximates a point source . . . ) we could make a reflection hologram.

Directional Pixels

How about a setup like E-Ink. Instead of light-dark beads, make beads that are transmissive in one orientation and reflective in the other. Or beads that are oddly-shaped and bend light according to their orientation. We would require an electrode surface of much higher resolution than E-Ink has been using to make holograms.

Field-Recordable Hologram

A huge hologram can be set up and recorded in the field. Just slather a surface (wall) with an old-fashioned photosensitive emulsion. Set up a coherent-light strobe and a couple of mirrors. Flash. Slather the wall with an evaporating fixer/bleaching solution. Shine a spotlight on your picture to have a permanent, vivid 3-D picture of whatever was there when the flash went off.

Next, use a material that can be recorded onto multiple times. Or continuously. Something like the phosphor in TVs . . . but permanent until erased and sensitive to something like microwaves which we can conveniently send through plain air. Every paintable display idea needs some way to get the image into it; it seems like we should try to use that input signal as a power source for the image change.

To get enough resolution for a hologram use a material that gets prepared to change by one wavelength but actually records a second wavelength. Make some tight diffraction pattern in the first wavelength on the image. Scan the phase of the pattern while changing the image to record an image with higher resolution than you can project. Or use just one frequency of light, just pulsed at different rates.

Back up one of these projectable holograms with a paintable piezoelectric or OLED-type emitter, and it seems like we have a relatively simple reconfigurable holographic display.

A display comprising one or more blocks each having one or more pixels wherein one or more of the pixels comprises one or more subpixels and wherein one or more of the subpixels is adapted to cause light to escape with a directed profile. A signal source is in operable communication with the one or more blocks and a controller associated with each block and directing action of subpixels according to a signal communicated from the source to the controller for each blank.

While preferred embodiments of the invention have been shown and described, various modifications and substitutions may be made thereto without departing from the spirit and scope of the invention. Accordingly, it is to be understood that the present invention has been described by way of illustration and not limitation.

What is claimed:

1. A display comprising:
a multiplicity of rigid blocks each having a multiplicity of pixels, each pixel having a multiplicity of subpixels with each subpixel being adapted to cause light to escape with a directed profile;
a signal source in radio frequency connection to each of said blocks;
a receiver in each of said blocks to receive the radio frequency signal from the source;
a transmitter in each block capable of communicating with receivers in other blocks;
a controller in each of said blocks and connected to the receiver in each block, said controller taking instruction from said receiver and directing light output and direction of each subpixel in each respective block; and
a position and orientation sensor associated with each of said blocks.

2. A display as claimed in claim 1 wherein the adaptation is a light steering element.

3. A display as claimed in claim 2 wherein the light steering element is a louver.

4. A display as claimed in claim 2 wherein the light steering element is a diffraction grating.

5. A display as claimed in claim 2 wherein the light steering element is a lens.

6. A display as claimed in claim 2 wherein the light steering element is a cylindrical lenslet.

7. A display as claimed in claim 2 wherein the light steering element is a spherical lenslet.

8. A display as claimed in claim 1 wherein said one or more pixels has a light emitting segment or light reflecting segment.

9. A display as claimed in claim 1 wherein said one or more pixels has an opaque segment.

10. A display as claimed in claim 1 wherein said one or more pixels are multifaceted.

11. A display as claimed in claim 10 wherein the multifaceted pixel is configured as a buckyball.

12. A display as claimed in claim 10 wherein the multifaceted pixel is an array of hemispheres.

13. A display as claimed in claim 1 wherein the position and orientation sensor is a magnetic field sensor that aligns to the Earth's field or a reference magnet placed near the display.

14. A display as claimed in claim 1 wherein the position and orientation sensor is a gravitational employing an accelerometer.

15. A display as claimed in claim 1 wherein the position and orientation sensor is a light.
